(19) United States
(12) Patent Application Publication
(10) Pub. No.: US 2017/0154564 A1
(43) Pub. Date: Jun. 1, 2017

(54) DISPLAY PANEL AND DISPLAY DEVICE

(71) Applicant: Wuhan China Star Optoelectronics Technology Co., Ltd., Wuhan (CN)

(72) Inventors: Zhenzhou XING, Shenzhen (CN); Qingcheng ZUO, Shenzhen (CN); Man LI, Shenzhen (CN)

(73) Assignee: Wuhan China Star Optoelectronics Technology Co., Ltd., Wuhan (CN)

(21) Appl. No.: 14/994,437

(22) Filed: Jan. 13, 2016

(30) Foreign Application Priority Data
Dec. 1, 2015 (CN) 201510870312.2

(51) Int. Cl. G09G 3/20

(52) U.S. Cl. CPC G09G 3/2092; G09G 2310/0289; G09G 2330/023; G09G 2320/02

(57) ABSTRACT

The present invention discloses a display panel and a display device, comprising a GOA stage transfer circuit, n scan lines and a signal process device, wherein the GOA stage transfer circuit comprises n GOA units which are cascade connected, and an ith GOA unit in the GOA stage transfer circuit is employed to charge an ith scan line, and the signal process device is coupled to an output end of any one or more of GOA units in the GOA units which are cascade connected, and the signal process device is employed to compare a signal outputted by the output end of any one or more of GOA units in the GOA units which are cascade connected with a target setting value to obtain a comparison result, and to adjust a value of a register in a driving chip according to the comparison result.

### FIELD OF THE INVENTION

The present invention relates to a display technology, and more particularly to display panel and a display device.

### BACKGROUND OF THE INVENTION

The Gate Driver On Array (GOA) technology is a skill to integrate the gate driving circuit of the display device on the array substrate. With utilizing the GOA technology, the used amount of IC can be reduced, and thus to reduce the production cost and the power consumption of the product. Besides, the GOA technology also can realize the narrow frame of the display device.

The GOA circuit generally comprises a plurality of GOA units which are cascade connected, and each GOA unit corresponds to one row of pixel zones. The one row of the pixel zones comprises a plurality of sub pixel zones, and a thin film transistor is formed in each sub pixel zone. Gates of the plurality of thin film transistors in the row of the pixel zones are coupled, and output ends of the GOA units can be coupled to the gates of the thin film transistor close to the GOA unit in the plurality of thin film transistors. The GOA unit can control the on and off of the plurality of thin film transistors in the one row of pixel zones with the voltage level high and low of the driving signal outputted thereby. Specifically, as the GOA unit outputs the driving signal of high voltage level, the driving signal of high voltage level can control the plurality of thin film transistors in the one row of pixel zones to be on, and as the GOA unit outputs the driving signal of low voltage level, the driving signal of low voltage level can control the plurality of thin film transistors in the one row of pixel zones to be off.

However, the GOA circuit can be easily influenced by environment, process conditions, and output abnormality occurs thereby. Thus, it results in the bad display effect of the display device.

### SUMMARY OF THE INVENTION

The technical issue that the embodiment of the present invention solves is to provide a display panel and a display device, achieving the display effect promotion of the display device.

The embodiment of the present invention provides a display panel, comprising a GOA stage transfer circuit, n scan lines and a signal process device, wherein the GOA stage transfer circuit comprises n GOA units which are cascade connected, and an ith GOA unit in the GOA stage transfer circuit is employed to charge an ith scan line, and the signal process device is coupled to an output end of any one or more of GOA units in the GOA units which are cascade connected, and the signal process device is employed to compare a signal outputted by the output end of any one or more of GOA units in the GOA units which are cascade connected with a target setting value to obtain a comparison result, and to adjust a value of a register in a driving chip according to the comparison result.

Selectably, the signal process device is positioned on a mainboard of a terminal, and the output end of any one or more of GOA units in the GOA units which are cascade connected is coupled to the mainboard of the terminal with a flexible circuit board.

Selectably, the display panel is positioned in the terminal.

Selectably, the display panel is positioned outside the terminal.

Selectably, the signal process device is coupled to an output end of the last stage GOA unit in the GOA units which are cascade connected.

The embodiment of the present invention further provides a display device, comprising a display panel and a base plate, and the display panel comprises a GOA stage transfer circuit, n scan lines and a signal process device, wherein the GOA stage transfer circuit comprises n GOA units which are cascade connected, and an ith GOA unit in the GOA stage transfer circuit is employed to charge an ith scan line, and the signal process device is coupled to an output end of any one or more of GOA units in the GOA units which are cascade connected, and the signal process device is employed to compare a signal outputted by the output end of any one or more of GOA units in the GOA units which are cascade connected with a target setting value to obtain a comparison result, and to adjust a value of a register in a driving chip according to the comparison result.

Selectably, the signal process device is positioned on a mainboard of a terminal, and the output end of any one or more of GOA units in the GOA units which are cascade connected is coupled to the mainboard of the terminal with a flexible circuit board.

Selectably, the display device is positioned in the terminal.

Selectably, the display device is positioned outside the terminal.

Selectably, the signal process device is coupled to an output end of the last stage GOA unit in the GOA units which are cascade connected.

By implementing the embodiment of the present invention, it is capable of comparing a signal outputted by the output end of any one or more of GOA units in the GOA units which are cascade connected with a target setting value to obtain a comparison result, and to adjust a value of a register in a driving chip according to the comparison result. Consequently, when the output signal outputted by the GOA unit has problems, the abnormality existing in the output signal outputted by the GOA unit can be detected. Then, the adjustment can be implemented to promote the display result of the display device.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structure diagram of one GOA unit provided by prior art;

FIG. 2 is a circuit diagram of one display panel provided by the present invention;

FIG. 3 is a circuit diagram of another display panel provided by the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Specifically, the terminologies in the embodiments of the present invention are merely for describing the purpose of the certain embodiment, but not to limit the invention. Examples and the appended claims be implemented in the present invention requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

The transistors employed in the embodiment of the present invention all can be the thin film transistors, field effect transistors or other elements with the same property. According to the function in the circuit, the transistors employed in the embodiment of the present invention mainly are switch transistors. Besides, the transistors employed in the embodiment of the present invention comprise two types, P type switch transistor and N type switch transistor. The P type switch transistor is on when the gate is at low voltage level, and off when gate is at high voltage level, and N type switch transistor is on when the gate is at high voltage level, and off when gate is at low voltage level.

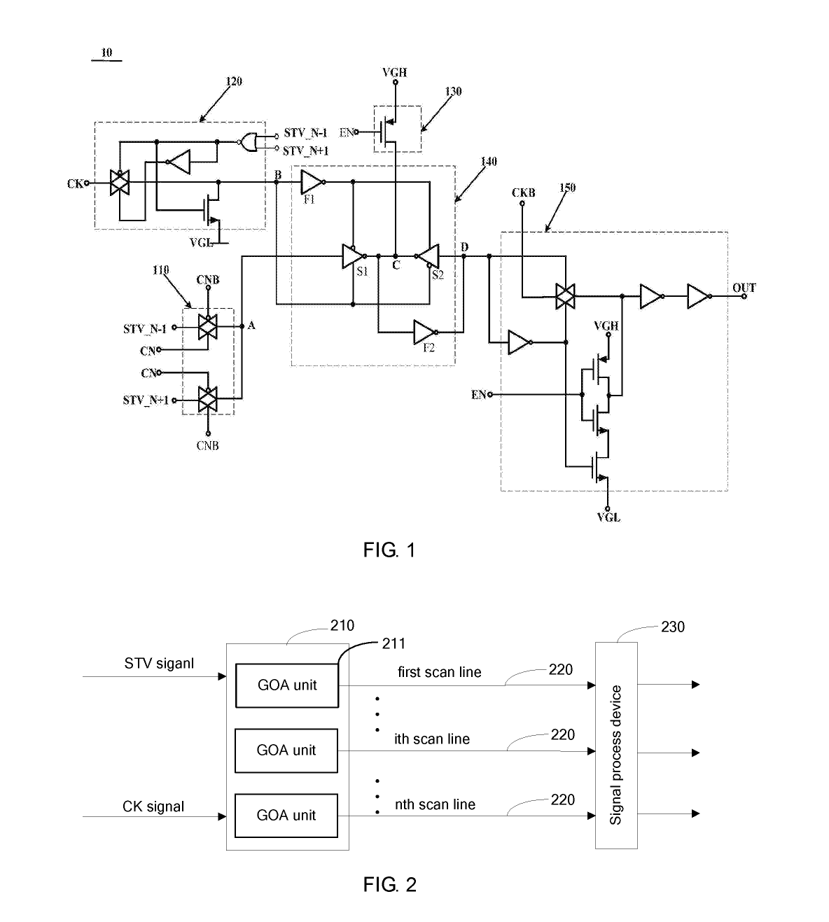

Please refer to FIG. 1, which shows a structure diagram of one GOA unit 10 provided by prior art. As referring to FIG. 1, the GOA unit 10 can comprises an input module 110, a power consumption reduction module 120, a reset module 130, a shift register module 140 and an output module 150.

The input module 110 is respectively coupled to a first input signal end STV_N−1, a second input signal end STV_N+1, a first node A, a first control signal end CN and a second control signal end CNB, and employed to write a first input signal of the first input signal end STV_N−1 or a second input signal of the second input signal end STV_N+1 into the first node A under control of a first control signal of the first control signal end CN or a second control signal of the second control signal end CNB.

The power consumption reduction module 120 is respectively coupled to the first input signal end STV_N−1, the second input signal end STV_N+1, a first clock signal end CK, a first power source signal end VGL and a second node B, and employed to write a first clock signal of the first clock signal end CK or a first voltage source signal of the first power source signal end VGL into the second node B under control of the first input signal of the first input signal end STV_N−1 and the second input signal of the second input signal end STV_N+1.

The reset module 130 is respectively coupled to a second power source signal end VGH, a third control signal end EN and a third node C, and employed to write a second power source signal of the second power source signal end VGH into the third node C under control of a third control signal of the third control signal end EN.

The shift register module 140 is respectively coupled to the first node A, the second node B, the third node C and a fourth node D, and employed to write a signal of the first node A into the fourth node D or output a signal of the third node C to the fourth node D under control of a signal from the second node B.

The output module 150 is respectively coupled to the fourth node D, a second clock signal end CKB, the first power source signal end VGL, the second power source signal end VGH, the third control signal end EN and an output signal end OUT, and employed to output a second clock signal of the second clock signal end CKB or the first power source signal of the first power source signal end VGL from the output signal end OUT under control of the signal from the fourth node D, or employed to output a second power source signal of the second power source signal end VGH from the output signal end OUT under control of the third control signal from the third control signal end EN.

As shown in FIG. 1, the voltage level of the driving signal outputted by the output signal end OUT of the GOA unit 10 is related to all of the CK signal, the CKB signal and the SW signal. By adjusting the CK signal, the CKB signal, the SW signal, the adjustment to the voltage level of the driving signal outputted by the output signal end OUT of the GOA unit 10 can be realized. Moreover, the signal values of the CK signal, the CKB signal and the SW signal are all stored in the register in the driving chip.

Please refer to FIG. 2. FIG. 2 is a circuit diagram of one display panel provided by the present invention. The display panel provided by this embodiment comprises a GOA stage transfer circuit 210, n scan lines 220 and a signal process device 230. The GOA stage transfer circuit 210 comprises n GOA units 211 which are cascade connected, and an ith GOA unit 211 in the GOA stage transfer circuit 210 is employed to charge an ith scan line 220, and the signal process device 230 is coupled to an output end of any one or more of GOA units 211 in the GOA units 211 which are cascade connected. i, n are both positive integers, and 0<i<n.

The signal process device 230 can be integrated on the display panel, or can be set on the mainboard of the terminal. When the signal process device 230 is integrated on the display panel, the signal process device 230 can be coupled to the output end of any one or more of GOA units; when the signal process device 230 is set on the mainboard of the terminal, it can be coupled to the mainboard of the terminal with the flexible circuit board. The display panel is positioned in the terminal, or positioned outside the terminal. The setting can be determined according to the actual demands.

When the display panel is activated, the SW signal is inputted to the GOA stage transfer circuit 210 to start scanning the scan lines 220. In cooperation of the CK signal, the GOA stage transfer circuit 113 controls and accomplishes charging the first scan lines 220 by the first GOA unit 211 to charging the nth scan line 220 by the nth GOA unit 211 for accomplishing the scan to the image signals of the display device.

The signal process device 230 collects the signal outputted by the output end of any one or more of GOA units 211 in the GOA units 211 which are cascade connected, and compares a signal outputted by the output end of any one or more of GOA units 211 in the GOA units 211 which are cascade connected with a target setting value to obtain a comparison result, and adjusts a value of a register in a driving chip according to the comparison result until the signal outputted by the output end of any one or more of GOA units 211 in the GOA units 211 which are cascade connected meets the requirement. The target setting value can be set according to actual demands.

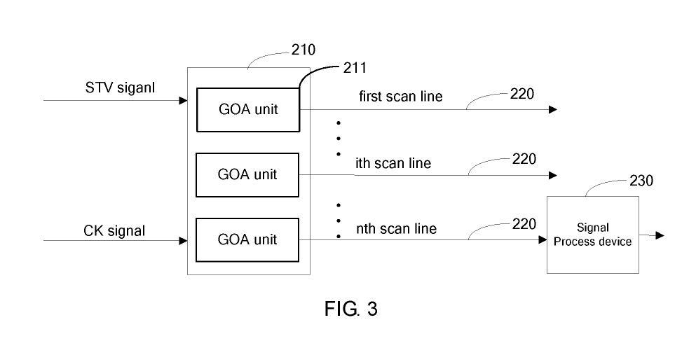

In another embodiment, as shown in FIG. 3, for convenience and storage saving, the signal process device 230 also can only coupled to the output end of the last stage GOA unit 211 in the GOA units 211 which are cascade connected, and compares the signal outputted by the output end of the last stage GOA units 211 with the target setting value to obtain a comparison result, and adjusts the value of the register in the driving chip according to the comparison result until the signal outputted by the output end of the last stage GOA units 211 meets the requirement.

By implementing the embodiment of the present invention, it is capable of comparing a signal outputted by the output end of any one or more of GOA units in the GOA units which are cascade connected with a target setting value to obtain a comparison result, and to adjust a value of a register in a driving chip according to the comparison result. Consequently, when the output signal outputted by the GOA unit has problems, the abnormality existing in the output signal outputted by the GOA unit can be detected. Then, the adjustment can be implemented to promote the display result of the display device.

It is understandable in practical to the person who is skilled in the art that all or portion of the processes in the method according to the aforesaid embodiment can be accomplished with the computer program to instruct the related hardwares. The program can be stored in a readable storage medium if the computer. As the program is executed, the processes of the embodiments in the aforesaid respective methods can be included. The storage medium can be a hardisk, an optical disc, a Read-Only Memory (ROM) or a Random Access Memory (RAM).

Above are embodiments of the present invention, which does not limit the scope of the present invention. Any modifications, equivalent replacements or improvements within the spirit and principles of the embodiment described above should be covered by the protected scope of the invention.

What is claimed is:

1. A display panel, comprising a GOA stage transfer circuit, n scan lines and a signal process device, wherein the GOA stage transfer circuit comprises n GOA units which are cascade connected, and an ith GOA unit in the GOA stage transfer circuit is employed to charge an ith scan line, and the signal process device is coupled to an output end of any one or more of GOA units in the GOA units which are cascade connected, and
the signal process device is employed to compare a signal outputted by the output end of any one or more of GOA units in the GOA units which are cascade connected with a target setting value to obtain a comparison result, and to adjust a value of a register in a driving chip according to the comparison result.

2. The display panel according to claim 1, wherein the signal process device is positioned on a mainboard of a terminal, and the output end of any one or more of GOA units in the GOA units which are cascade connected is coupled to the mainboard of the terminal with a flexible circuit board.

3. The display panel according to claim 2, wherein the display panel is positioned in the terminal.

4. The display panel according to claim 2, wherein the display panel is positioned outside the terminal.

5. The display panel according to claim 1, wherein the signal process device is coupled to an output end of the last stage GOA unit in the GOA units which are cascade connected.

6. A display device, comprising a display panel and a base plate, and the display panel comprises a GOA stage transfer circuit, n scan lines and a signal process device, wherein the GOA stage transfer circuit comprises n GOA units which are cascade connected, and an ith GOA unit in the GOA stage transfer circuit is employed to charge an ith scan line, and the signal process device is coupled to an output end of any one or more of GOA units in the GOA units which are cascade connected, and
the signal process device is employed to compare a signal outputted by the output end of any one or more of GOA units in the GOA units which are cascade connected with a target setting value to obtain a comparison result, and to adjust a value of a register in a driving chip according to the comparison result.

7. The display device according to claim 6, wherein the signal process device is positioned on a mainboard of a terminal, and the output end of any one or more of GOA units in the GOA units which are cascade connected is coupled to the mainboard of the terminal with a flexible circuit board.

8. The display device according to claim 2, wherein the display device is positioned in the terminal.

9. The display device according to claim 2, wherein the display device is positioned outside the terminal.

10. The display device according to claim 1, wherein the signal process device is coupled to an output end of the last stage GOA unit in the GOA units which are cascade connected.
